(19) United States
(12) Patent Application Publication
(10) Pub. No.: US 2020/0130280 A1
(43) Pub. Date: Apr. 30, 2020

(54) METHOD FOR DETERMINING PRINTING PROCESS PARAMETER VALUES, METHOD FOR CONTROLLING A 3D PRINTER, COMPUTER-READABLE STORAGE MEDIUM AND 3D PRINTER

(71) Applicant: Heraeus Additive Manufacturing GmbH, Hanau (DE)

(72) Inventor: Michael Klosch-Trageser, Freigericht-Neuses (DE)

(73) Assignee: Heraeus Additive Manufacturing GmbH, Hanau (DE)

(21) Appl. No.: 16/494,072

(22) PCT Filed: Mar. 13, 2018
(86) PCT No.: PCT/EP2018/056176

§ 371 Date: Sep. 13, 2019

(30) Foreign Application Priority Data
Mar. 15, 2017 (EP) 17161098.3

(51) Int. Cl. B29C 64/386; B33Y 50/00; B33Y 30/00; B29C 64/268; G05B 19/4099

(52) U.S. Cl. CPC B29C 64/386; B33Y 50/00; G05B 2219/49023; B29C 64/268; G05B 19/4099; B33Y 30/00

(57) ABSTRACT

In 3D printing, due to the geometry to be printed, inhomogeneous material properties of the printing product can occur. This problem is solved by a method of determining printing process parameter values for a 3D printer, including producing at least one meta-model, wherein the at least one meta-model indicates a relationship between at least one printing process parameter and at least one product property of a printing product for object data, wherein the object data indicate a digital representation of an object to be printed. The method also includes determining at least one first printing process parameter value for the at least one printing process parameter in a first printing area and at least one second printing process parameter value for the at least one printing process parameter in a second printing area taking into consideration the at least one meta model and the object data.

The invention relates to a method of determining process parameter values for a 3D printer, a method of controlling a 3D printer, a computer-readable storage medium and a 3D printer.

A large number of methods are known for producing three-dimensional workpieces from one or more fluid or solid working materials.

For example, in so-called “fused deposition modeling” (FDM) a workpiece is built up in layers from a meltable plastic. For this, through heating and extrusion a wire-like plastic is applied by means of a nozzle to plate on a workbench. Through hardening of the plastic, layers can be applied one after the other.

In stereolithography (SLA) a liquid epoxy resin is filled into a chamber, wherein the surface of the epoxy resin is irradiated point by point with a laser in such a way that at the irradiated points the epoxy resin hardens. After each irradiation stage the hardened workpiece is lowered a few millimetres in the epoxy resin so that a further layer can be printed.

In selective laser sintering (SLS) or selective laser melting (SLM) as well as electromagnetic melting (SEBM), in the chamber a thin layer of a plastic in powder form, a metal or a ceramic is applied to a plate. Through a laser beam or an electron beam the layers are melted in stages into the powder bed in accordance with a layer contour of the component. On completion of one layer the building platform is slightly lowered and a new layer applied.

It has been found that in particular in the case of SLS, SLM or SEBM methods the geometry to be printed is of particular importance for the properties of the printed product. If, for example, in a small area material is melted at short intervals, local overheating of the material occurs. Due to the high temperature, cooling there is considerably slower than in other areas of the component, through which the material properties of the finished component are negatively influenced.

The quality of the print product therefore varies greatly and leads to unsatisfactory results.

On the basis of this prior art it is the aim of the present invention to propose a method, a computer-readable storage medium and a 3D printer which address the aforementioned disadvantages. In particular, it is the aim of the present invention to propose a method which permits printing with homogeneous material properties. It is also the aim of the present invention to propose a method and a 3D printer which reduce rejects. In addition, it is the aim of the invention to allow constant printing results irrespective of the geometry to be printed.

The aim is achieved by a method of determining printing process parameter values for a 3D printer according to claim 1. More particularly, the aim is achieved by a method comprising:
Producing at least one meta-model, wherein the at least one meta-model indicates a relationship between at least one printing process parameter and at least one product property of a printing product for object data, wherein the object data indicate a digital representation of an object to be printed;
Determining at least one first printing process parameter value for the at least one printing process parameter in a first printing area and at least one second printing process parameter value for the at least one printing process parameter in a second printing area taking into consideration the at least one meta model and the object data.

The core of the invention is therefore that the values for the printing process parameters for different printing area are different.

In the processing of metallic and ceramic materials it is to date usual that printing process parameters such as output, scan speed, line spacing or overlapping remain unchanged during the 3D printing process. However, the aforementioned process parameters have a considerable influence on the properties of the printing product. For example, the porosity, roughness, density, texture or such like are determined by the printing process parameters.

The invention uses a meta model which indicates the relationship between at least one printing process parameter and at least one product property of the printing product. Using the meta model it can thus be predicted how the properties of a printing product change when the printing process parameter values are altered. An essential advantage of the invention consists in the fact that the printing process parameter values are determined individually for object data.

In one form of embodiment the first printing process parameter value and the second printing process parameter value can differ, in particular, by a numerical value of greater than 0.03% of the first or the second printing process parameter value.

The printing process parameter values of the first printing area and of the second printing can therefore differ. Through this it is possible that certain printing areas will exhibit different material properties. In particular, the printing process parameter values can differ in such a way that, for example, a uniform increase in a parameter indicating a material property is achieved. In this way smooth transitions of print product properties are possible. For example, the density of the printing product in one area can increase evenly in one direction.

In one form of embodiment the above-described method can comprises the optimisation of at least one product property of the printing product using the at least one meta model and taking into consideration the object data.

Through the above-described embodiment it is possible for an object property, such as the porosity, to be kept constantly at a target value.

In one form of embodiment this optimisation can be a minimisation of an overall deviation of the at least one product property from a target value.

Through the above-described method the total deviation from a target value can thus be optimised. For example, the sum of individual deviations from a target value at a plurality of points to be printed can be determined, wherein the total deviation is the sum of the individual deviations. The total deviation can then be optimised through amending the printing process parameter values.

Furthermore, in one embodiment the optimisation can comprise minimising a gradient of a product property between melting tracks arranged next to each other. A melting track is defined by successively printed points within a layer. Printing can of course also be continuous so that a melting track is a contiguous printing area within a layer.

In one form of embodiment the method can also comprise:
simulating and/or experimentally determining at least one object property of the printing product for the object data and at least one assigned printing process parameter;
producing at least one process window card, wherein the at least one process window card can indicate an allocation of at least one printing process parameter value of the assigned printing process parameter to a product property value of the printing product,
wherein the at least one meta model can be produced taking into consideration the at least one process window card.

According to the above-described form of embodiment a meta model can already be derived before printing experimentally or by means of simulation methods. This has the advantage that the meta model is, for example, determined at the manufacturer of a 3D printer and is supplied with the 3D printer. The customer then only has to indicate the desired product parameter values on the printer itself or in corresponding software, e.g. slicing software.

A process window card can be defined as a discrete illustration of one or more printing process parameters on one or more product properties. A process window card can, for example, be stored as a multidimensional array or as a dictionary.

In one form of embodiment the first printing area can be assigned to a printing layer to be printed and the second printing area to same layer to be printed.

It is also possible that within a layer different printing process parameter values for a printing process parameter are used. In this way the quality of the printing product is increased.

In one form of embodiment the object data can indicate the geometry of the printing product.

The object data can be available, for example, as STL data or also as STEP or IGES data. It is also possible to use the invention with a large number of current data formats.

In a further form of embodiment the first printing area and the second printing area can be selected taking into consideration the object data, in particular a local geometry.

Selecting the printing areas has the advantage that in geometrically difficult areas printing process parameter values can be adjusted. For example, printing areas which only require the printing of a fine structure require different printing process parameter values from areas in which flat structures are printed. Selecting the printing areas taking into consideration the object data or a local geometry therefore allows particularly precise setting of the printing process parameter values.

In one form of embodiment the at least one process window card can indicate at least one quality range of the printing product, wherein the at least one product property value can lie within defined, in particular, numerical limits values in the process window card.

Through the selection of at least one quality area it can be ensured that certain requirements relating to the printing product are also observed when changing the printing process parameter values. The quality areas can be determined either manually or mechanically. For example, in tensile tests the strength of the printing product can be checked, wherein the determined values, at which failure occurs, indicate the limits of the quality range. Microscopic examinations of the print product can be mechanically evaluated through image processing.

In one form of embodiment the at least one printing process parameter can indicate,
the output of the 3D printer or a radiation source;
the scanning speed,
the layer thickness of a layer;
the overlapping of printing paths or melting traces,
the line spacing of printing paths or melting traces,
the focus diameter of a laser or an electron beam,
the pulse sequence of a radiation source,
the construction room temperature and/or
the number of exposures, the exposure pattern.

A large number of printing process parameter values can thus be adjusted so that optimal printing product results are achieved.

The task is also solved by a method of controlling a 3D printer according to claim 11. In particular, the task is solved by a method of controlling a 3D printer comprising the following:
determination of at least one first printing process parameter value for a printing process parameter and at least one second printing process parameter value for the printing process parameter for a 3D printer according to any one of the above-described forms of embodiment;
controlling of the 3D printer using the first at least one and the second at least one printing process parameter value.

The determined printing process parameter values can thus be used in order to control a 3D printer. In this way optimum print product qualities are achieved. In particular it is made possible that the printing process parameters and the printing process parameter values are determined before printing. However, in other forms of embodiment it is also possible for the printing process parameter values to be newly calculating during printing.

In one form of embodiment controlling of the 3D printer can include the setting of a printer parameter using the first at least one and/or the second at least one printing process parameter value.

The form of embodiment described above therefore allows a 3D printer to be adjusted when being controlled. In this way the product properties can be changed during operation. For example, the scan speed of the 3D printer can be set to the determined printing process parameter value for the scan speed.

In one form of embodiment controlling of the 3D printer can include the operation of the 3D printer using the first printing process parameter value in a first area of a printing layer and the operation of the 3D printer using the second printing process parameter value in a second area of the printing layer.

With the form of embodiment described above it thus becomes possible for the printing process parameter values to be changed within a single layer. In this way homogeneous material properties of the entire print product can be achieved.

The task is also solved by a computer-readable storage medium which contains instructions which cause (at least) one processor to implement a method according to one of the preceding forms of embodiment when the instructions are carried out by the processor.

Similar or identical advantages are achieved to those already described with the method set out above.

The task is also solved by a 3D printer according to claim 15. More particularly the task is solved by a D3 printer comprising the following:
a storage medium as described above,
a processor that is designed to implement the instructions store on the storage medium;
a radiation source,

wherein the processor is also designed to:
control the radiation source using a first printing process parameter value in a first area of a printing layer and to
control a radiation source using a second printing process parameter value in a second area of the printing layer.

In one form of embodiment the 3D printer can be designed as a electron beam printer or as a laser printer.

The described advantages are therefore present particularly when using electron beam printers or laser printers.

All the described process stages can be in the form of software or hardware. For example integrated circuit boards can be used which implement the process stages. In particular, FPGAs or digital signal processors can be used. In some forms of embodiment calculation steps can be carried out on a server, wherein the result of the calculations are transmitted via a network, in particular a TCP/IP network.

The invention will be described below in more detail by way of examples of embodiment with reference to the attached schematic drawings.

In these

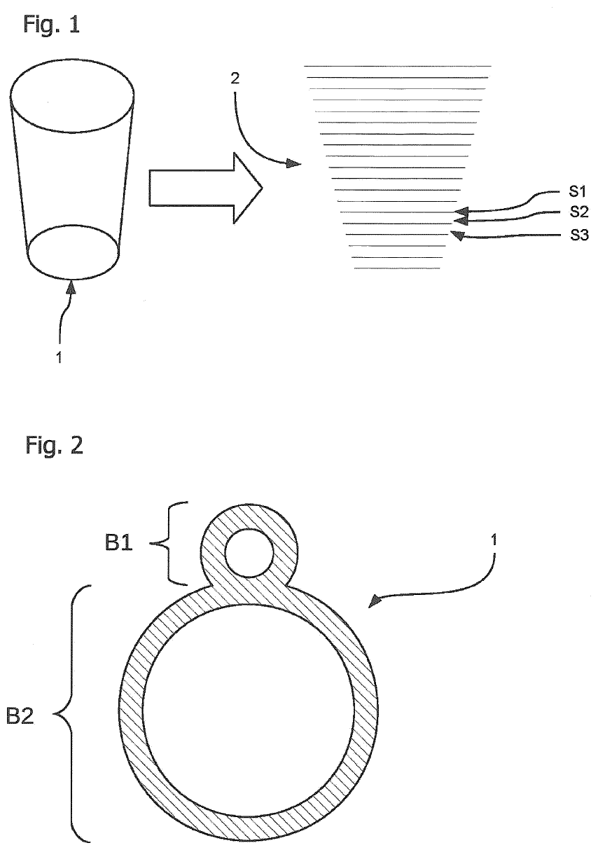

FIG. 1 schematically shows the printing of an object;

FIG. 2 shows a schematic view from above of an object to be printed;

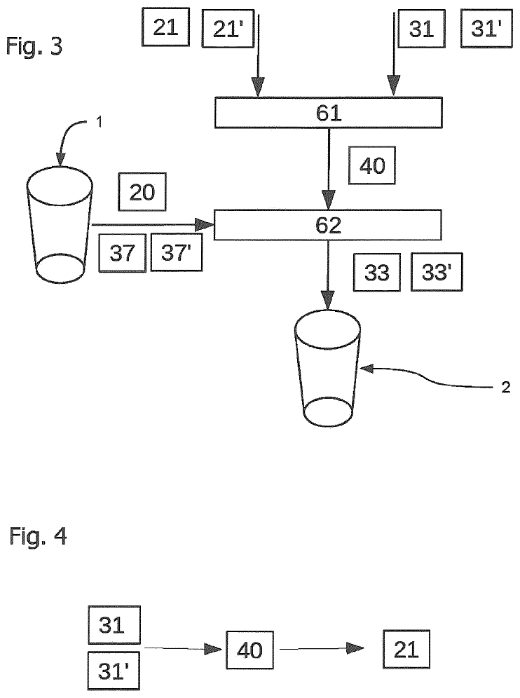

FIG. 3 shows a flow diagram for determining printing process parameter values;

FIG. 4 shows the relationship between a product property and printing process parameters;

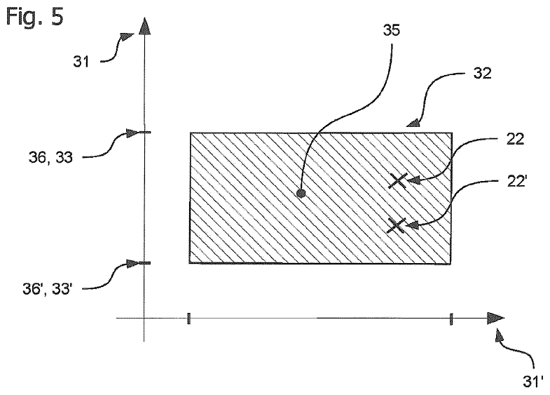

FIG. 5 shows as view of a process window card;

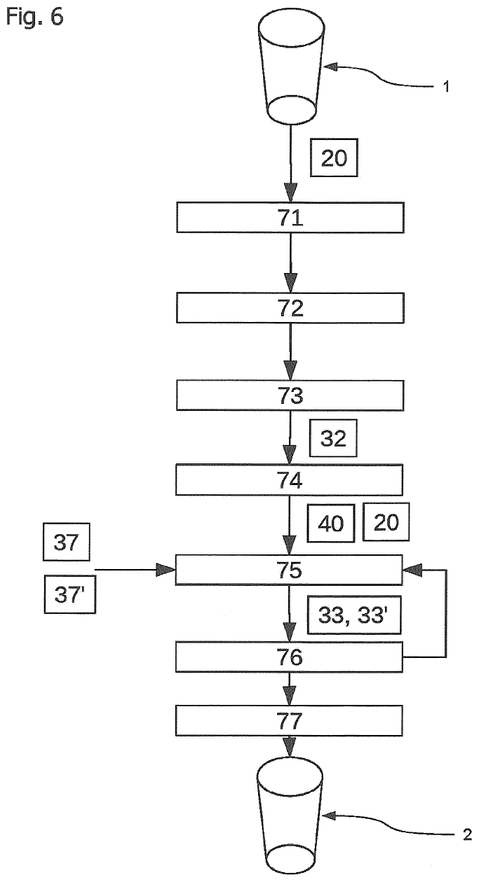

FIG. 6 shows a flow diagram for printing a printing product; and

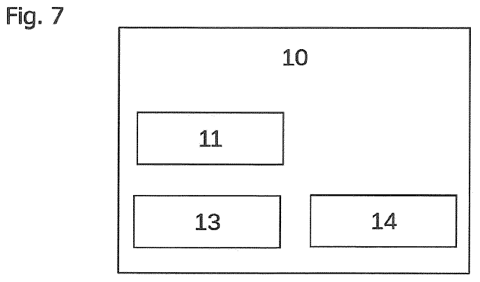

FIG. 7 shows a schematic view of a 3D printer.

Below, the same reference numbers are used for identical or identically-functioning parts.

FIG. 1 schematically shows the printing of an object 1. For this, object data 20, which describe the object 1, are provided as CAD data. Various data formats such as, for example, IGES or STL, can be used for this. The object data 20 are then “sliced”. This means that software determines the layers to be printed. In one example of embodiment, from the “sliced” object data 20 a machine-readable code which can be read by the 3D printer, is produced, e.g. in a so-called build processor.

During printing the printing product 2 is built up of a plurality of layers S1, S2, S3. In the SLS process a layer S1, S2, S3 is always built up by melting a powder. The thus produced welding paths are precisely arranged so that a stable material composite is produced. In this way the printing product 2 is built up layer by layer.

FIG. 2 shows a schematic view from above of an object 1 to be printed. The object 1 comprises two printing areas B1 and B2. The first printing area B1 is an essentially circular area with a small radius. The second printing area B2 is also circular but with a much greater radius than the first printing area B1.

The printing areas B1 and B2 are therefore defined by the geometry to be printed. The areas B1 and B2 each define a local geometry. In order to obtain a homogeneous printing product 2 it is necessary for different settings to be used when printing the printing product 2 as a function of the area B1, B2 to be printed. Otherwise inhomogeneous material properties of the printing product 2 can result.

FIG. 3 shows a flow diagram for printing an object 1. In a first step 61 a meta model 40 is first produced. The meta model 40 indicates a relationship between printing process parameters 31, 31′ and a product property 21, 21′ of a printing product 2. Print product properties 21, 21′ are for example the porosity of the printing product, the roughness, the density, the texture or similar properties. The printing process parameters 31, 31′ therefore have an influence on the above variables. The printing process parameters 31, 31′ include, for example, the output of a 3D printer 10 or a laser, the layer thickness S1, S2, S3, the overlapping of print paths or melting traces, the line spacing of print paths or melt traces, the focus diameter of a laser, the pulse sequences or also the number of exposure in an interval of time.

The production of meta models 40 is explained in more detail in connection with FIG. 5.

In step 62 printing process parameter values 33, 33′ are determined for the printing process parameters 31, 31′. For this, object data 20 indicting the geometry of an object 1 are analysed. Using the meta model 40 printing process parameter values 33, 33′ can be determined so that the desired product properties of the printing product 2 are achieved. The desired product properties are described by target values 37, 37′.

In one example of embodiment a cylinder is printed. In an area facing a base surface the cylinder has a small radius which becomes larger in the direction away from the base. Due to the different cross-sections of the cylinder, the scan speed and the laser output, for example, can be adjusted in such a way that the properties of the melt bath (depth, length) produced by the laser is the same in all printing layers S1, S2, S3 or approximately the same. In this way, homogeneous material properties of the printing product 2 can be achieved.

FIG. 4 shows the relationship of a product property 21 and printing process parameters 31, 31′ described by a meta model 40.

The meta model 40 therefore indicates how the product property 21 changes when the values of the printing process parameters 31, 31′ are changed. For each value of a printing process parameter 31, 31′ the meta model 40 indicates the value of a product property 21. Accordingly, the meta model 40 in the shown example of embodiment is a continuous model. The meta model 40 can be implemented through spline interpolation for example. It is also conceivable for the meta model 40 to be produced as a neuronal network or using another regression analysis of discrete value, in particular a process window card 32.

FIG. 5 shows a schematic view of a process window card 32 which is used for producing a meta model 40. FIG. 5 shows a coordinate system, which is set up through the two axes 31, 31′. The process window card 32 indicates the relationship of the individual values of the printing process parameters 31, 31′ to the product property values 22, 22′. In the shown example of embodiment only one product property 32 is shown.

In other examples of embodiment a process window card 32 can indicate a multi-dimensional parameter space which indicates the connection of a plurality of printing process parameters 31, 31′ to a plurality of product properties 21, 21′.

The process window card 32 shown in FIG. 5 is produced experimentally. For the experimental determination of a process window card 32 a plurality of printing products are printed using different printing process parameter values 33, 33′. The printing results 2 can then be examined in a laboratory so that the product property values 22, 22′ are determined precisely.

In one example of embodiment the process window cards 32 are determined through simulation methods. In the event of known relationships of printing process parameters 31, 31′ to product properties 21, 21′ such a simulation can be carried out. In this way expensive experiments can be avoided.

A process window card 32 thus sets out a discrete quantity of printing process parameter values 33, 33′ and accompanying product property values 22, 22′. Moreover, the process window card 32 contains details of which printing process parameter values 33, 33′ indicate an acceptable quality range 35. Printing process parameter values 33, 33′ which are outside the quality range 35 lead to unsatisfactory printing results. A quality range 35 is, for example, indicated by two limit values 36, 36′. The limit values 36, 36′ then indicate the outer limits of the quality range 35.

From the process window card 32 a meta model 40 is then produced. The discrete points of the process window card 32 can be transferred by way of new methods, e.g. splicing interpolation or the training of a neuronal network, into a continuous model.

FIG. 6 shows a schematic flow diagram for printing an object 1. For the object 1 object data 20 are initially provided, here as STL data, which indicate the geometry of the printing product 2. Normally in a so-called slicing step the digital 3D model, which is indicated by the object data 20, is divided into layers which correspond to the layers S1, S2, S3 to be printed. In step 72 the 3D model divided into layers S1, S2, S3 is used to determine a plurality of object properties 21, 21′ of the printing product 2 with the accompanying process parameters 31, 31′. Based on the determined object properties 21, 21′, in step 73 a process window card 32 is produced. In step 74 the process window card 32 is used determine a meta model 40. As has already been described above spline interpolation or the training of a neuronal network can be used.

In step 75, printing process parameter values 33, 33′ are determined using the meta model 40 and the object data 20. A printing path can also be determined. The printing path can be used to determine the printing process parameter values 33, 33′.

In step 76 the determined printing process parameter values 33, 33′ can be optimised. This means that, amongst other things, it is ensured that printing product property values 22, 22′ are always within a quality range 35 determined by a process window card 32. In addition, for the product property values 22, 22′ to be anticipated with certain printing process parameter values 33, 33′ an overall error for the object data 20 can be calculated, wherein for all product property values 22, 22′ the difference from target values 37, 37′ is calculated. Using known minimisation methods, e.g. gradient methods, the overall error can be minimised through adjustment of the process parameter values 33, 33′.

In step 77 the determined printing process parameter values 33, 33′ are used for controlling a 3D printer. In a first example of embodiment, in a first area B1 a first printing process parameter 33 is used to set a printer parameter 12. In a second area B2 a second printing process parameter 33′ is used to change the printer parameter 12. Thus, when controlling the 3D printer 10 different printing process parameter values 33, 33′ are used with one layer S1, S2, S3, in particular as a function of the geometry of the object 1 to be printed.

An advantage of the described method consists in particular in that the meta model 40 only has to be calculated once for a material. It can then be used for any number of workpieces with different geometries.

FIG. 7 shows an example of a 3D printer 10 which comprise a radiation source 11, a processor 14 and a storage device 13. In the storage device 13 instructions are stored which cause the 3D printer 10 to control the radiation source 11 taking into consideration the printing process parameter values 33, 33′.

At this point it is pointed out that all the above-described parts, seen by themselves and in any combination, particularly the details shown in the drawings, are claimed as essential for the invention. Modifications thereto are familiar to a person skilled in the art.

### REFERENCES LIST

1 Object

2 Printing product

10 3D printer

11 Radiation source

12 Printer parameter

13 Storage device

14 Calculating system

20 Object data

21, 21′ Product property

22, 22′ Product property value

31, 31′ Printing product parameter

32 Process window card

33, 33′ Printing process parameter value

35 Quality range

36, 36′ Limit values

37, 37 Target value

40 Meta model

S1-S3 Printing layer

60 Method of determining a set of process parameter

61, 62 Process step

70 Method of determining a set of process parameter

71-77 Process step

B1, B2 Printing area

1-16. (canceled)

17. A method of determining printing process parameter values for a 3D printer comprising:
producing at least one meta-model, wherein the at least one meta-model indicates a relationship between at least one printing process parameter and at least one product property of a printing product for object data, wherein the object data indicate a digital representation of an object to be printed; and
determining at least one first printing process parameter value for the at least one printing process parameter in a first printing area and at least one second printing process parameter value for the at least one printing process parameter in a second printing area taking into consideration the at least one meta model and the object data.

18. The method of claim 17, wherein the first printing process parameter value and the second printing process parameter value differ by a numerical value greater than 0.03% of the first or the second printing process parameter value.

19. The method of claim 17, wherien an optimisation of at least one product property of the printing product using the at least one meta model and taking into consideration the object data.

20. The method of claim 19, wherein the optimisation comprises a minimisation of an overall deviation of at least one product property from a target value, and/or a gradient of a product property between melt paths arranged next to each other.

21. The method claim 17 further comprising:
simulating and/or experimentally determining at least one object property of the printing product for the object data and at least one assigned printing process parameter; and
producing at least one process window card, wherein the at least one process window card can indicate an allocation of at least one printing process parameter value of the assigned printing process parameter to a product property value of the printing product,
wherein the at least one meta model is produced taking into consideration the at least one process window card.

22. The method of claim 17, wherien the first printing area is assigned to a printing layer to be printed and the second printing area to the same layer.

23. The method of claim 17, wherein the object data indicate the geometry of the printing product.

24. The method of claim 23, wherein the first printing area and the second printing area are selected taking into consideration a local geometry.

25. The method of claim 17, wherein the at least one process window card indicates at least one quality range of the printing product, wherein the at least product property value lies within defined numerical limit values in the process window card.

26. The method of claim 17, wherein the at least one printing process parameter indicates
the output of the 3D printer or a radiation source;
the scanning speed,
the layer thickness of a layer;
the overlapping of printing paths or melting traces,
the line spacing of printing paths or melting traces,
the focus diameter of a laser or an electron beam,
the pulse sequence of a radiation source,
the construction room temperature and/or
the number of exposures, the exposure pattern.

27. A method of controlling a 3D printer comprising:
determining at least one first printing process parameter value for a printing process parameter and at least one second printing process parameter value for the printing process parameter for a 3D printer according to claim 17; and
controlling the 3D printer using the first at least one and the second at least one printing process parameter value.

28. The method of claim 27, wherein controlling the 3D printer includes the setting of a printer parameter using the first at least one and/or the second at least one printing process parameter.

29. The method of claim 27, wherein controlling the 3D printer includes the operation of the 3D printer using the first printing process parameter in a first area of a printing layer and the operation of the 3D printer using the second printing process parameter value in a second area of the printing layer.

30. A computer-readable storage medium that contains instructions that cause the at least one processor to implement the method of claim 27 when the instructions are carried out by the processor.

31. A 3D printer comprising the following:
the storage medium of claim 30,
a processor that is designed to implement the instructions stored on the storage medium;
a radiation source, wherein;
the processor controls the radiation source using a first printing process parameter value in a first area of a printing layer and controls the radiation source using a second printing process parameter value in a second area of the printing layer.

32. The 3D printer according to claim 31, wherein the 3D printer is designed as an electron beam printer or as a laser printer.
